(19) United States
(12) Patent Application Publication
(10) Pub. No.: US 2019/0184291 A1
(43) Pub. Date: Jun. 20, 2019

(54) AUGMENTED REALITY GAME THAT PROMOTES IN-STORE SALES

(71) Applicant: ANDAR, INC., Livonia, MI (US)

(72) Inventors: Clarity Patton, South Lyon, MI (US); Lesli Walsh, Livonia, MI (US); Doug Willett, Plymouth, MI (US); Steve Yatooma, Birmingham, MI (US)

(21) Appl. No.: 16/227,694

(22) Filed: Dec. 20, 2018

Related U.S. Application Data
(60) Provisional application No. 62/608,181, filed on Dec. 20, 2017.

(51) Int. Cl. A63F 13/792; A63F 13/26

(52) U.S. Cl. CPC A63F 13/792; A63F 13/26

(57) ABSTRACT

A method of playing an augmented reality game includes establishing a player profile including visual representations of the player and default or selected characteristics of the player's persona, visiting at least one retail establishment, locating a virtual game piece in at least one predetermined location within the retail establishment, capturing or collecting a located virtual game piece, and earning a reward based on captured or collected virtual game pieces. The reward may be useful when making a purchase from the retail establishment or may be a prize from a provider of the game.

### BACKGROUND

The proliferation of the Internet and the ways in which it is used has impacted far more than just the fields of computing and communication. There is an increasing trend of facilitating day-to-day activities online. Shopping is one example. Purchasing habits have changed significantly with more business being conducted through a website. Consumers are more likely to purchase an increasing variety of goods online.

While such changes present new opportunities in some aspects of business, they introduce new challenges in others. For example, retailers used to have to compete with others in the same general geographic region. Now, however, retailers from anywhere in the world may be competing for the same sale.

Additionally, some retailers have invested substantial resources in traditional “brick and mortar” stores and their brand is linked with those stores. Customer loyalty can be increased as a result of a favorable in-store experience and personal customer service, which are not available through a website. Competing with online retailers, however, is still a concern because there are added costs associated with a physical store that are not incurred when maintaining a website. The trend of doing more shopping online instead of going to the store compounds the potential downside to maintaining a traditional or physical store. Many retailers could benefit from increased numbers of shoppers visiting their stores and there is a need for new ways to draw customers into a store.

### SUMMARY

An illustrative example method of playing an augmented reality game includes establishing a player profile including visual representations of the player and default or selected characteristics of the player's persona, visiting at least one retail establishment, locating a virtual game piece in at least one predetermined location within the retail establishment, capturing or collecting a located virtual game piece, and earning a reward based on captured or collected virtual game pieces. The reward may be useful when making a purchase from the retail establishment or may be a prize from a provider of the game.

In an example embodiment having one or more features of the method of the previous paragraph, the game points are converted to retail loyalty points from the establishment where the virtual game piece was captured or collected.

An illustrative example embodiment of a system that facilitates playing an augmented reality game includes a database of player profiles and locations of virtual game pieces within participating retail establishments. A server associated with the database communicates with player mobile devices to allow players to see virtual game pieces in an augmented reality display on a mobile device when the player is at a location of a virtual game piece. The server determines when the player captures or collects a game piece using the mobile device and includes information regarding the collected game piece in that player's profile in the database.

Various features and advantages of embodiments of this invention will become apparent to those skilled in the art from the following description. The drawings that accompany the detailed description can be briefly described as follows.

### BRIEF DESCRIPTION OF THE DRAWINGS

FIG. 1 schematically illustrates selected portions of a system for playing a game designed according to an embodiment of this invention.

FIG. 2 schematically illustrates selected features of a mobile station configured to play a game according to an embodiment of this invention.

FIG. 3 is a flowchart diagram summarizing a method of conducting a game designed according to an embodiment of this invention.

FIG. 4 illustrates selected features of a mobile station used for playing a game designed according to an embodiment of this invention.

FIG. 5 illustrates selected aspects of establishing an environment for playing a game designed according to an embodiment of this invention.

### DETAILED DESCRIPTION

Embodiments of this invention include a game based on an augmented reality, location-based treasure hunting application that may be installed on mobile devices, such as Android and iPhone devices. Game players navigate through an indoor space, such as a retail establishment that may be a single company's store or a shopping mall, to search for virtual coins, gems or other game pieces and collect them to earn loyalty rewards at participating retail locations.

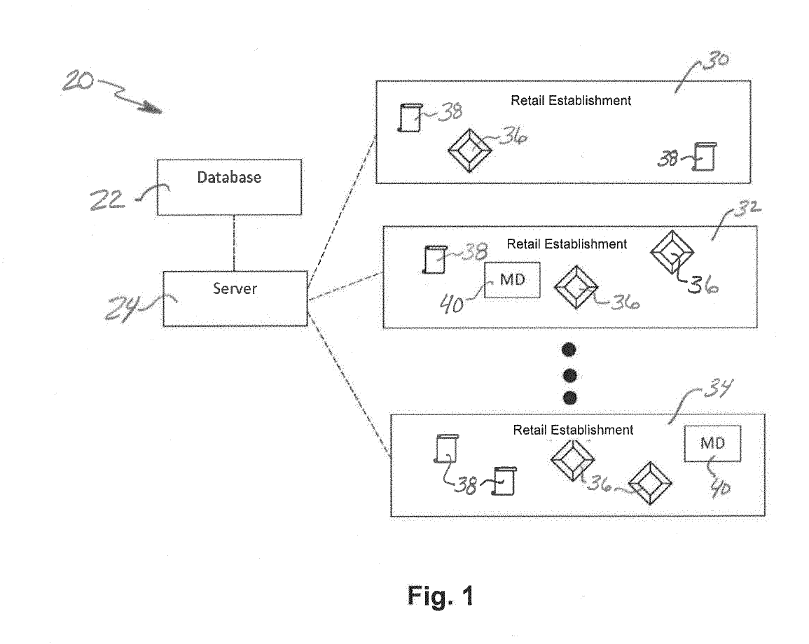

FIG. 1 schematically shows an example system 20 that facilitates playing an augmented reality game including a database 22 and a server 24. The database 22 and server 24 are shown separately for discussion purposes and those skilled in the art who have the benefit of this description will realize that the database 22 and server 24 could be realized through a single device or a larger number of devices that may be in various geographic locations. Additionally, the server 24, the database 22, or both could be implemented using cloud computing resources.

A few example participating retail establishments 30, 32 and 34 are illustrated in FIG. 1. Each retail establishment serves as an environment in which virtual game pieces 36, 38 are situated in predetermined locations. Players use mobile stations 40, such as smart phones, to play the game.

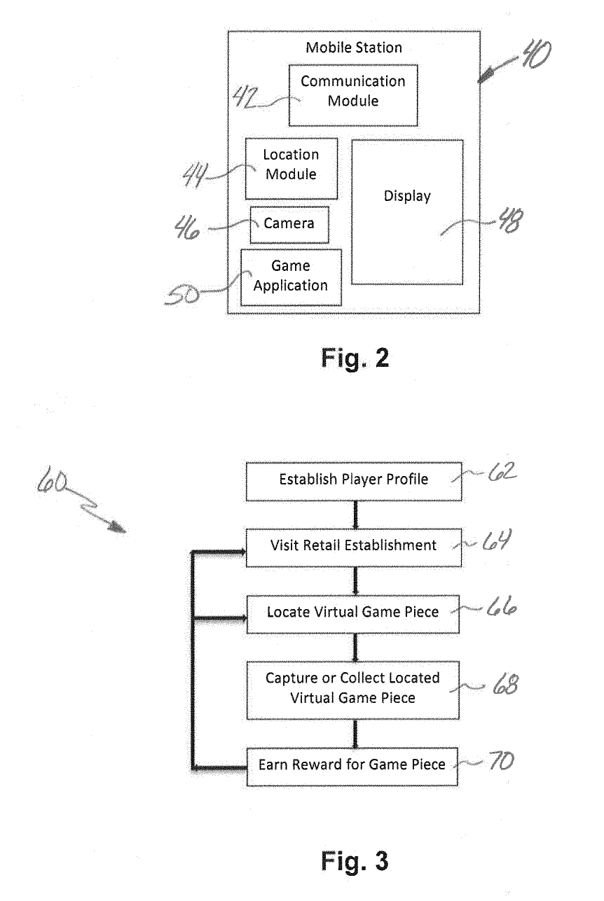

An example mobile station 40 is shown in FIG. 2. The mobile station includes a communication module 42 that operates in a known manner to access any of a cellular network, a data network, or the Internet. A location module 44 is configured to provide location information to the server 24 indicating a location or position of a player within a participating retail establishment. A camera 46 provides image information regarding the actual, physical environment in the immediate vicinity of the player. A display 48 provides a visual display of the image information gathered by the camera and any other display sought by a player.

The mobile station 40 has been provided with a game application 50, which may be downloaded onto the mobile station for example. The game application 50 essentially configures the mobile station to allow an individual to play the game using the mobile station.

FIG. 3 is a flow chart diagram 60 that summarizes an example way of playing the game. At 62, a player establishes a player profile through an interface on the mobile station 40. At 64, a player visits a participating retail establishment 30, 32 or 34. While there, the player locates a virtual game piece at 66 on an augmented reality display on the display 48. At 68, the player uses the mobile station 40 to collect or capture the game piece and earns a reward for that game piece at 70.

The player profile established at 62 is created or entered by the player using the mobile station 40. The profile information is stored in the database 22 in this example. In some embodiments at least some of the player profile information is stored on the mobile station 40 and accessed by the server 24 as needed.

The player profile information includes a unique identifier that distinguishes the player from others and reward information that is based on the player's performance playing the game. The player profile includes records regarding the player's game statistics, such as level of expertise, number of game pieces collected, and rewards earned at participating retailers.

In the example embodiment, each player is able to customize a virtual persona and environment for the game, and information regarding that persona is stored as part of the player profile. One example embodiment includes a kingdom and castle theme for the game. Players use an interface on their respective mobile devices 40 to outfit their player personas and build their castles, selecting from a variety of wardrobe accessories and architecture styles ranging from medieval to futuristic.

An example player interface screen used to create and edit the player persona allows the player to choose from a variety of personas. Example embodiments include avatar creation programs/scripts with customizable interfaces and assets from services such as www.ageofgames.net or www.rinmarugames.com

The virtual persona allows the player to adopt a role in the game and the player's character and accessories can be grown and enhanced through those categories. Each player has the ability to create an individualized game environment including a castle, for example. Over time as the player advances through the game, the player may use earned points or rewards to enhance the castle with more deluxe furnishings, for example.

In an example embodiment, the castle becomes the home screen for the game and is visible on the display 48 whenever the player is not actively using the capture screen to collect a game piece. Since the camera functionality of the mobile device 40 will be used to provide an augmented reality display on the mobile device display screen 48 for capturing game pieces, and camera functionality tends to drain battery power, one feature of the illustrated example is to provide a power-conserving dwell screen when the player is not near a virtual game piece.

The game application 50 will allow players to register for retailers loyalty rewards programs, which will be included as part of the player profile, without leaving the mobile environment. Through play, the user can accumulate loyalty points for a retailer at which they are not yet a loyalty program member. They will be given the option to join each retailer's loyalty program at any time, for example during the process of cashing in rewards points by having them converted into the retailer's loyalty program points.

Some embodiments include player interests as part of the player profile. A display screen will provide an interface through which a player may indicate areas of interest. These selections can be used, for example, as part of a functionality that directs targeted marketing toward the user. Interest and topic categories may be selected by the player and will be included in that player's profile.

The available topics list in one example is based on products and services available from the participating retailers. Example topics include: Fashion—Men, Fashion—Women, Fashion—Boys, Fashion—Girls, Shoes, Sports, Food, Cooking, Arts & Crafts, Music, Books, Apparel, Pets, etc.

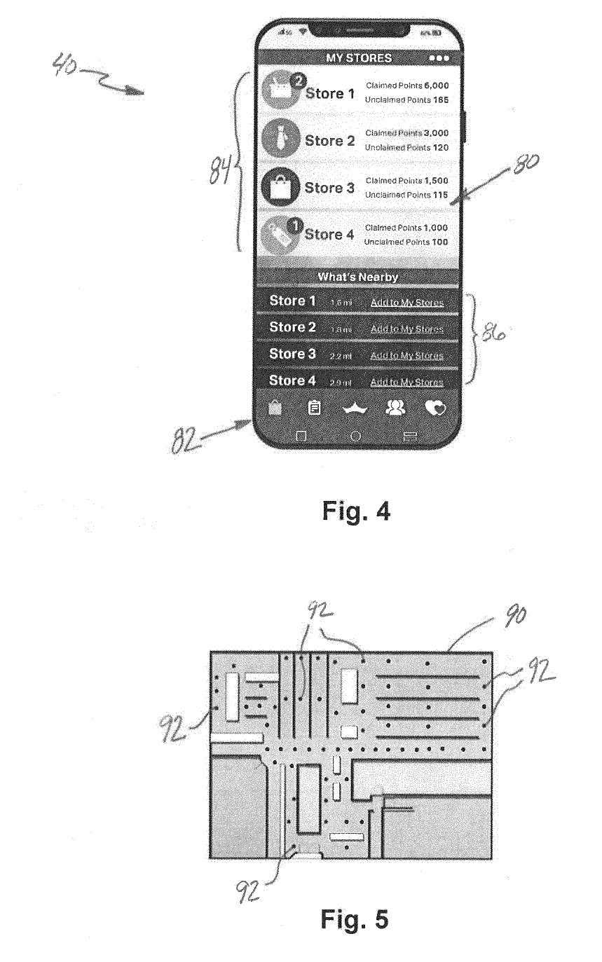

The player interface in one embodiment includes a bottom carousel as a permanent part of the display. FIG. 4, which shows an example player interface 80, includes an example listing 82 of such carousel items. In this example the player has easy access to information regarding stores the player has visited or considers a favorite, reminders regarding calendared events or promotional events through the game, game activation and settings, a listing of friends, and a listing of available offers.

This example screen display 80 shows the list of participating retail establishments. The player will be able to quickly view point totals for all participating establishments from this screen. For example, stores are sorted in descending order by point totals earned by the player at each and shown at 84 with an indication of the store name, logo and points earned by the player. The stores may also be sorted by closest geographical location as shown at 86. Tapping on the store name will open up a store details page with contact information, access to directions and other useful information.

Participating stores that the player has not visited or where the player has not yet played the game or collected game pieces are displayed at the bottom of the list, sorted by name. Players can tap to add a store to the player's list. The player will be able to scroll through the store list with simple swipe up and down motions. Tapping on a store from the list will take the player to the selected store's details page. Stores and other retail locations, such as malls and shopping centers, will automatically be added to the list once a user has used the app in that location.

The control panel in this embodiment will display icons for the most popular social media services. Example icons include those for Twitter, Facebook, Instagram, Pinterest, Google+, LinkedIn and Snapchat. Tapping on one of the platform icons will activate the screen for the specific social media application and give the user the ability to share game progress or status through that application.

A player that is registered and has a player profile is able to visit participating retail establishments (at 64 in FIG. 3). The database 22 includes information regarding participating retail establishments, such as identifier information, location information and virtual game piece placement information. Retail establishments include stores, malls, restaurants, and other buildings where individuals can purchase goods or services. The retailers or owners of the retail establishments have an incentive to participate and allow virtual game pieces to be geographically located in their facilities because it increases customer traffic and players seeking out game pieces will encounter products to potentially purchase.

The illustrated example embodiment uses indoor location techniques to allow the mobile device 40 to determine when the player visits a participating retail establishment. Such indoor location techniques are also used by the mobile station 40 to determine when the player is near the location of a virtual game piece. Since GPS signals can be weak to non-existent in many interior areas, some embodiments include a known Bluetooth Low Energy (BLE) Beacon supported system or a SLAM Based augmented reality system. One example embodiment includes Google's Eddystone program as a BLE beacon system in participating retail establishments. Eddystone can be detected by both Android and iOS devices and can be powered by a battery which can last for up to two years. Beacons can also use an external power source if needed.

Some embodiments include a hybrid location-based and SLAM based game that uses the player's position, which is detected through beacons (that are not illustrated) to provide guidance through the game environment within each participating retail establishment.

Once the player is in a participating retail establishment the player may locate virtual game pieces (at 66 in FIG. 3). When the player is close enough proximity to a virtual game piece, the mobile device 40 provides a notification that the augmented reality portion of the game may be activated or used to capture the game piece. In some embodiments the augmented reality display will automatically activate when the mobile device 40 is brought within a predetermined range of the virtual game piece position.

The example embodiment includes a compass displayed on the mobile device 40 that always points in the direction of the nearest game piece. The compass will guide the player around the retail establishment until the player is within range to capture the game piece.

The database 22 includes information regarding participating retail establishments whose facilities include locations where virtual game pieces can be collected by players when the player is in a location of such a game piece. The server 24 accesses the information in the database 22 and communicates with a player's mobile device 40 when that individual is playing the game. The server 24 provides information to the mobile device 40 regarding the location of game pieces in a vicinity of the mobile device 40. When a player approaches the location of a game piece the display 48 on the mobile device 40 presents an augmented reality image that shows the actual environment within a field of view of the camera 46 with an image of the virtual game piece superimposed onto the image of the actual environment when the camera is appropriately oriented. The game piece appears to be situated in the actual store. The player can use the mobile device 40, by actuating a touch screen function for example, to capture or collect the game piece (at 68 in FIG. 3).

If the player does not have the game application 50 in use when approaching a collectible game piece, the server 24 pushes a notification to the mobile station 40 and the player will be notified by an alert indicating that a game piece is near.

In one example, looking at the floating virtual game piece on the display 48 for 3 seconds, which may be determined based on the mobile device 40 being held steady with the game piece on the display 48, will cause the capture animation feature of the game application 50 to run allowing the player to capture the game piece. Some embodiments include a capture icon or button that may be activated by contacting the corresponding portion of the display screen 48.

When the game piece is a coin it will be deposited into the player's bank once captured, a coin counter will be incremented, and the player will hear a coin click or “ching” sound. The animation will then move off or fade out on the augmented reality display. Closing the capture screen or function will return the player to the home or dwell screen.

The server 24 communicates information to the database 22 regarding any captured game pieces and any associated reward or status earned by the player for inclusion in that player's profile information.

Conversion formulas, averages and maximum daily coin limits determine how many game points translate to any retailer's rewards currency. This standardized tool will give the retailers the ability to determine how aggressive they want to be with their approach to rewarding players. It will also allow these values to be adjusted by an administrator of the system 20.

As players accumulate points they will have the option at any time to cash them in for reward points valid with the retailer where the points were earned. By cashing in, the user will trigger the server 24 to send the proper value in rewards points to that retailer's loyalty program to be available for use. When the user cashes in earned points, the rewards point balance for that retailer decreases an appropriate amount based on the value of points cashed in (e.g., the balance with that retailer goes to 0) at that time. In some embodiments game points continue to accumulate and may never go to 0. This gives the game many options for “leveling up” players.

One of the aspects of this invention includes establishing the playing field or universe including locations for game pieces in a plurality of retail establishments, for example. As schematically shown in FIG. 5 a map 90 defines the boundaries for the game area during game set up or configuration. The same map 90 will be used during play to identify each player's location within the corresponding establishment. Each participating establishment will have its own map. The maps will not be visible to the player, since the player will be navigating the interior of the retail establishment based on what actually exists at that location and the compass indication provided on the mobile device 40. The map information is stored in the database 22 and utilized by the server 24.

The potential placement locations 92 for game pieces within a participating establishment will be evenly spaced out within the game environment so that the “game board” can be randomized to activate different locations that change the game every day. There may be instances where the game board needs to remain static for longer time periods and those skilled in the art who have the benefit of this description will realize what interval works best for their particular implementation.

For each participating establishment, the database 22 contains an array of possible game piece locations 92 along with counters for available game pieces and game pieces found. Each day the possible game pieces counter will be reset, and the game pieces will be randomized within the game piece locations array. A game piece location will consist of X, Y, Z parameters for the game piece's latitude, longitude, and altitude.

Establishing game piece locations includes using a floor plan of each participating building or location. FIG. 5 schematically shows an example floor plan on the map 90 with multiple possible game piece locations 92 throughout the floor plan. According to one embodiment, an automated algorithm determines possible game piece locations based on the dimensions and parameters of the building or room and places the potential game piece locations at regular intervals (e.g., every 5 feet) throughout the floor plan. Game pieces are randomly assigned to or placed at some or all of the possible locations 92 for selected periods of time such that different game pieces may be in different locations on different days. This allows a player who visits a particular store more than once to have a different experience playing the game in that store on different days.

The dimensions of each participating establishment are gathered through onsite inspection or by obtaining physical dimension and configuration information from the participating business. Such information sets range parameters for each game board or store. Actual latitude and longitude of the store boundaries are used in one example to establish position location within the database 22.

Once a floorplan has been created, an authorized user or game administrator can begin adding Points of Interest (POI) locations to the floorplan. In this embodiment, clicking on the floor plan will display an Add POI Dialogue Box. The floor plan will support drag and drop functionality so that POI locations can easily be moved around on the floorplan once they are added. The floorplan or game board can be configured remotely and adjusted on site as desired.

Details for each POI include Title, Enabled Toggle, and an Asset Preview window. As POI locations are added to the store map, they will also appear on the left side of the display screen 48 in a POI list. The information that may be included in such a list can pertain to the merchandise available at a particular location in that building or establishment so that game pieces may be custom located relative to particular inventory in a store based on preferences expressed by the participating business.

Games and systems for facilitating them that are designed according to embodiments of this invention provide a unique augmented reality experience. Individuals have additional incentive to visit participating retail establishments compared to shopping online. Game players also earn game and loyalty points that can be used for discounts or other rewards at participating establishments. The businesses that participate benefit by increasing foot traffic and potential sales.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of playing an augmented reality game, the method comprising:
establishing a player profile including visual representations of the player and default or selected characteristics of a persona for the player;
visiting at least one retail establishment;
locating a virtual game piece in at least one predetermined location within the retail establishment;
capturing or collecting the located virtual game piece; and
earning a reward based on the captured or collected virtual game piece.

2. The method of claim 1, wherein the reward is useful for making a purchase from at least one of a selected establishment or the retail establishment where the virtual game piece was captured or collected.

3. The method of claim 1, wherein the reward comprises at least one of
loyalty points from the retail establishment,
a discount at the retail establishment,
an item from the retail establishment,
a monetary prize from one of the retail establishment or a provider of the game, or
an enhancement to the player profile or the persona.

4. The method of claim 1, wherein
the persona includes a virtual appearance of the player, a home screen appearance, and a virtual dwelling for the player; and
the earned reward is selectively redeemable for enhancing at least one feature of the persona.

5. The method of claim 1, wherein
locating the virtual game piece comprises using an augmented reality display on a mobile device;
capturing or collecting the located virtual game piece comprises using the augmented reality display and at least one other function of the mobile device, and
the augmented reality display shows the virtual game piece superimposed over an image of a corresponding portion of the retail establishment.

6. The method of claim 1, wherein there are increasing levels of reward corresponding to increasing numbers of captured or collected virtual game pieces and the method comprises
capturing or collecting a plurality of virtual game pieces to thereby increase the earned reward; and
selectively redeeming the earned reward or a portion of the earned reward.

7. A system that facilitates playing an augmented reality game, the system comprising:
a database of a plurality of player profiles and locations of virtual game pieces within participating retail establishments;
a server associated with the database, the server being configured to
communicate with a player's mobile device to allow a player to see at least one virtual game piece in an augmented reality display on a mobile device when the player is at a location of a virtual game piece in a retail establishment;
determine when the player captures or collects a game piece using the mobile device;
determine a reward associated with the captured or collected game piece; and
communicate information regarding at least one of the reward or the collected game piece to the database to include the information in the player profile of the player who captured or collected the game piece.

8. The system of claim 7, wherein the reward is useful for making a purchase from at least one of a selected establishment or the retail establishment where the virtual game piece was captured or collected.

9. The system of claim 7, wherein the reward comprises at least one of
loyalty points from the retail establishment,
a discount at the retail establishment,
an item from the retail establishment, or
a monetary prize from one of the retail establishment or a provider of the system.

10. The system of claim 7, wherein
the database comprises a plurality of player personas respectively associated with one of the players;
each persona includes a virtual appearance of the player, a home screen appearance, and a virtual dwelling for the player; and
the reward is selectively redeemable for enhancing at least one feature of the persona.

11. The system of claim 7, wherein
locating the virtual game piece comprises using an augmented reality display on a mobile device;
capturing or collecting the located virtual game piece comprises using the augmented reality display and at least one other function of the mobile device, and
the augmented reality display shows the virtual game piece superimposed over an image of a corresponding portion of the retail establishment.

12. The system of claim 7, wherein
there are increasing levels of reward corresponding to increasing numbers of captured or collected virtual game pieces;
the server determines a number of captured or collected virtual game pieces for each player that captures or collects a virtual game piece;
the server determines an increase in the level of reward for each player; and
the server facilitates a player selectively redeeming the earned reward or a portion of the earned reward.
